(19) United States
(12) Patent Application Publication
(10) Pub. No.: US 2006/0221427 A1
(43) Pub. Date: Oct. 5, 2006

(54) Impedance matching circuit for optical transmitter

(76) Inventors: Xin M. Wu, Alhambra, CA (US); Xiaowei Yao, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,837

(22) Filed: Mar. 31, 2005

(51) Int. Cl. G02F 1/03

(52) U.S. Cl. 359/241

(57) ABSTRACT

Impedance matching circuits for optical transmitters are disclosed. In one aspect, an impedance matching circuit may include an equalizer circuit, a resistor coupled between the equalizer circuit and ground, and an electro-absorption modulator or other light intensity modulator coupled in series with the equalizer circuit and coupled in parallel with the resistor. In a further aspect, the equalizer circuit may have an impedance that varies with frequency and may include an inductor, and a second resistor that is coupled in parallel with the inductor. Methods of making and using the impedance matching circuits are also disclosed. Optical transmitters, transceivers, and other systems including the impedance matching circuits are also disclosed.

### BACKGROUND

1. Field

Various different embodiments of the invention relate to impedance matching circuits for optical transmitters, methods of making the circuits, methods of using the circuits, and optical transmitters and systems including the circuits.

2. Background Information

Some optical transmitters use external light intensity modulators, such as, for example, electro-absorption modulators, in order to modulate intensity of light from a laser, or other light source, according to a modulation signal provided by a driver. An impedance mismatch may potentially exist between the driver and the electro-absorption modulator. In some optical transmitters the impedance mismatch may vary with frequency. The impedance mismatch may potentially contribute to problems, such as, for example, increased return loss, jitter, and/or eye closure.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of an optical transmitter, according to one or more embodiments of the invention.

FIG. 2 shows a circuit representation of an electro-absorption modulator, according to one or more embodiments of the invention.

FIG. 3 shows simulated return loss for an optical transmitter as a function of modulation frequency, according to one or more embodiments of the invention.

FIG. 4 shows measured return loss for an optical transmitter as a function of modulation frequency, according to one or more embodiments of the invention.

FIG. 5 shows measured filtered optical eye for an optical transmitter, according to one or more embodiments of the invention.

FIG. 6 is a block diagram of an optical transceiver, according to one or more embodiments of the invention.

FIG. 7 is a block diagram of a network, according to one or more embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

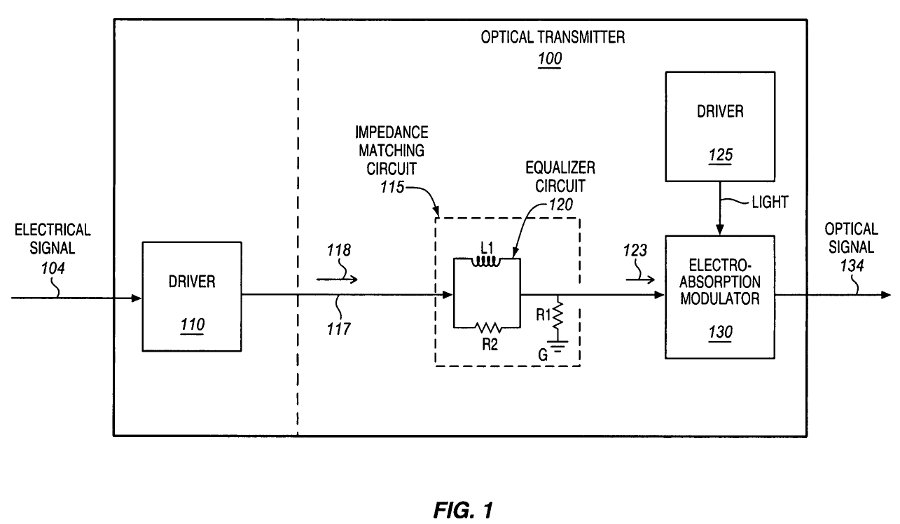

FIG. 1 is a block diagram of an optical transmitter 100, according to one or more embodiments of the invention. The optical transmitter includes a driver 110, an impedance matching circuit 115, an electro-absorption modulator 130, and a light source 125.

The optical transmitter may receive an electrical signal 104 as input. By way of example, the electrical signal may be provided by a host electronic device with which the optical transmitter is employed and may have been transformed by one or more processes, such as, for example, phase adjustment, co-alignment, line de-skewing, decoding, rate adjustment, scrambling, encoding, serialization, deskew, de-serialization, and combinations thereof. Such processes may be performed by logic disposed between the host electronic device and the driver, such as, for example, logic included in a physical medium attachment (PMA) device. However, the scope of the invention is not limited in this respect.

In any event, the electrical signal may be provided to the driver 110. The electrical signal may represent data, such as, for example, network data. The driver may generate a modulation signal 118 that may correspond to the electrical signal. In one or more embodiments of the invention, the modulation signal may include an electrical signal having different voltages that are modulated based, at least in part, on data or network data represented in the received electrical signal.

As shown, the driver is separated from other components of the driver by a dashed line. The dashed line is used to indicate that in some embodiments of the invention, the driver may not be included in an optical transmitter. For example, in one or more embodiments of the invention, an optical transmitter known as a transmitter optical sub-assembly (TOSA) may lack a driver, and the driver may rather be provided in an optical transceiver in which the TOSA may ultimately be included. In other optical transmitters, the driver may be included.

Referring again to FIG. 1, the optical transmitter also includes the impedance matching circuit 115. The impedance matching circuit is electrically coupled with, and directly electrically connected to, the driver in order to receive the modulation signal. The impedance matching circuit is also electrically coupled with, and directly electrically connected to, the electro-absorption modulator.

In this description and in the claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. For example, the driver may be electrically coupled with the electro-absorption modulator via the intervening impedance matching circuit.

The impedance matching circuit may help to match the impedance of the electro-absorption modulator with the impedance of the driver. Impedance is conventionally represented mathematically as a complex number. The complex number includes a sum of a real number and an imaginary number, where the real number represents resistance and the imaginary number represents reactance.

Impedance matching generally refers to an approach in which a circuit having impedance is included between a signal source and a signal destination in order to help improve the coupling of electrical signals from the signal source to the signal destination. Relatively strong signals may be coupled from the signal source to the signal destination when the impedance of the signal destination is substantially equal to the complex conjugate of the impedance of the signal source. Two impedances are complex conjugates when their resistances are equal and their reactances are equal in magnitude and opposite in sign.

At low frequencies, the imaginary number representing the reactance may tend to be negligible and the impedance may be predominantly represented by the real number representing the resistance. Accordingly, at low frequencies, relatively strong signals may be coupled from the signal source to the signal destination when the resistance of the signal destination is substantially equal to the resistance of the signal source. However, at high frequencies the imaginary number representing the reactance may no longer be negligible, but rather may contribute significantly to the impedance.

Now, the electro-absorption modulator generally has both resistance and capacitance, which may both contribute to its impedance. Without limitation, the resistance may potentially arise, at least in part, from materials associated with the electro-absorption modulator, and the capacitance may potentially arise, at least in part, from metal pads associated with the electro-absorption modulator and/or the thickness of the absorbing material of the electro-absorption modulator.

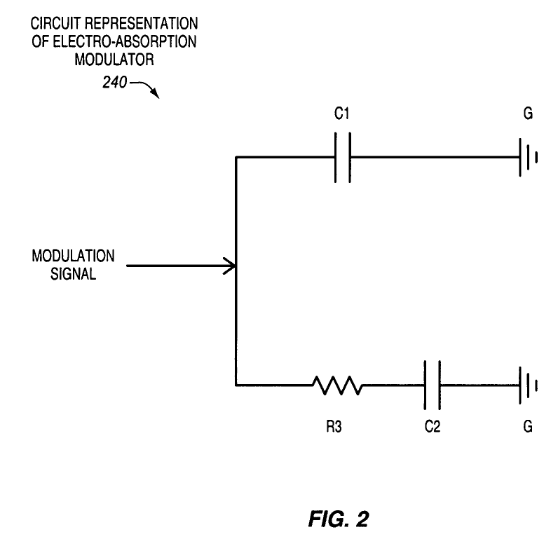

FIG. 2 shows one possible circuit representation 240 of an electro-absorption modulator, according to one or more embodiments of the invention. The circuit representation includes a first capacitor (C₁), a second capacitor (C₂), and a resistor (R₃). R₃ and C₂ are connected in series with one another. C₁ is connected in parallel with the series combination of R₃ and C₂. C₁ and C₂ are coupled to ground (G). By way of example, certain electro-absorption modulators may have a C₁ of about 0.9 picofarads (pF), a C₂ of about 0.25 pF, and an R₃ of about 11 Ohms, although the scope of the invention is not limited in this respect. Other values may be appropriate for other electro-absorption modulators. Note that the scope of the invention is not limited to this particular circuit representation or how well it models an electro-absorption modulator. Other electro-absorption modulators, as long as they have some capacitance, and/or as long as their impedance otherwise decreases or otherwise changes with increasing frequency, may benefit from impedance matching circuits in accordance with embodiments of the invention.

At low frequencies, such as, for example, at frequencies of less than about 1 gigahertz (GHz), the impedance of the electro-absorption modulator without the impedance matching circuits disclosed herein tends to be greater than the impedance of the driver. In order to improve the electrical coupling of the electro-absorption modulator with the driver, it may be advantageous to include an impedance matching circuit that may help to account for at least some of the difference in impedance between the electro-absorption modulator and the driver at low frequencies.

Further, at high frequencies, such as, for example, at frequencies greater than several GHz, the impedance of the electro-absorption modulator may decrease relative to the impedance of the driver. Without wishing to be bound by theory, this may be due, at least in part, to capacitance of the electro-absorption modulator. Often, the higher the frequency the more the impedance may be decreased by the capacitance. In order to improve the electrical coupling of the electro-absorption modulator with the driver, it may be advantageous to include an impedance matching circuit having impedance that increases with increasing frequency in order to help account for the decrease in impedance of the electro-absorption modulator relative to the impedance of the driver with increasing frequency.

Referring again to FIG. 1, the impedance matching circuit includes an equalizer circuit 120 and a first resistor (R₁). As used herein, unless specified otherwise, an equalizer circuit may refer to a circuit that is coupled in series with a line or path that connects an electrical signal source with a signal destination and that has a reactance that is capable of altering the frequency response of the line or path.

The equalizer circuit is electrically coupled in series with, and electrically connected in series to, the driver. The equalizer circuit is also electrically coupled in series with, and electrically connected in series to, the electro-absorption modulator. The illustrated equalizer circuit includes an inductor (L₁) and a second resistor (R₂). The second resistor (R₂) is electrically coupled in parallel with, and electrically connected in parallel to, the inductor.

The first resistor (R₁) is electrically coupled in series with, and electrically connected in series to, the equalizer circuit. The first resistor (R₁) is also electrically coupled and connected between the equalizer circuit and ground (G). Further, the first resistor (R₁) is electrically coupled in parallel with, and electrically connected in parallel to, the electro-absorption modulator.

At low frequencies, such as, for example, at frequencies less than about 1 GHz, the inductor may have negligible impedance, and may tend to resemble a short circuit. Most of the electrical current of a signal applied or otherwise provided to the equalizer circuit may tend to bypass the second resistor (R₂) and may tend to flow instead predominantly through the inductor. The first resistor (R₁) alone may predominantly help to match the impedance of the impedance of the electro-absorption modulator to the impedance of the driver. In one or more embodiments of the invention, the size of the first resistor (R₁) may be based, at least in part, on the difference in impedance between the electro-absorption modulator and the driver at low frequencies, such as, for example, at a frequency of about 1 GHz.

As the frequency is increased, the impedance of the inductor may increase. The inductor may no longer closely resemble a short circuit, but may rather offer a significant opposition to the flow of current. A greater portion of the current applied to the equalizer circuit may flow through the second resistor (R₂). Accordingly, the impedances of the equalizer circuit and of the impedance matching circuit may increase as the frequency is increased to several GHz, or higher. The increase in the impedance may help to at least partially account for the decrease in impedance of the electro-absorption modulator relative to the impedance of the driver at high frequencies, such as, for example, due to capacitance. The reactance of the inductor may be opposite in sign to the reactance of the capacitance of the electro-absorption modulator.

In one or more embodiments of the invention, at least a portion of the equalizer circuit, such as, for example, the second resistor (R₂) and/or the inductor (L₁), may be sized based, at least in part, on the relative decrease of the impedance of the electro-absorption modulator to that of the driver at high frequencies, such as, for example, at frequencies of about 10 GHz. Viewed from a different perspective, in one or more embodiments of the invention, at least a portion of the equalizer circuit, such as, for example, the second resistor (R₂) and/or the inductor (L₁), may be sized based, at least in part, on the amount of capacitance in the electro-absorption modulator.

It is difficult to place a precise circumference or limit on the size of the inductors and resistors that may be used in the impedance matching circuit, since their sizes may potentially vary with different types of drivers and light intensity modulators. By way of example, according to one or more embodiments of the invention, the impedance matching circuit may have a first resistor (R₁) that may range from about 25 to 100 Ohms, a second resistor (R₂) that may range from about 15 to 50 Ohms, and an inductor (L₁) that may range from about 0.4 to 1.5 nanohenries (nH). For example, in one or more embodiments of the invention, the first resistor (R₁) may range from about 40 to 80 Ohms, the second resistor (R₂) may range from about 25 to 40 Ohms, and the inductor (L₁) may range from about 0.8 to 1.2 nH. Such impedance matching circuits are believed to be suitable for a variety of drivers and electro-absorption modulators that are commonly employed in 10 GHz optical transmitters. However, the scope of the invention is not limited to just these sizes.

Now, as described above, the impedance matching circuit may help to avoid, or at least reduce, an impedance mismatch between the driver and the electro-absorption modulator. Reducing the impedance mismatch may help improve the electrical coupling of the driver with the electro-absorption modulator, which may help to reduce potential problems, such as, for example, one or more of poor return loss, jitter, and/or eye closure.

Referring again to FIG. 1, the optical transmitter also includes the electro-absorption modulator 130. The electro-absorption modulator is electrically coupled with, and electrically connected to, the impedance matching circuit. In particular, the electro-absorption modulator is electrically coupled in series with, and electrically connected in series to, the equalizer circuit, and the electro-absorption modulator is electrically coupled in parallel with, and electrically connected in parallel to, the first resistor (R₁). The electro-absorption modulator may receive a modulation signal 123 from the impedance matching circuit. The modulation signal received at the electro-absorption modulator may differ slightly from the corresponding modulation signal provided by the driver due, at least in part, to the intervening impedance matching circuit, although the data represented in the signal should be substantially the same.

The electro-absorption modulator is also optically coupled with the light source 125. The light source may emit or otherwise provide light, such as, for example, constant intensity light. Suitable light sources include, but are not limited to, laser diodes (LDs), light emitting diodes (LEDs), and other types of semiconductor light sources. In one or more embodiments of the invention, the light source may include a narrow bandwidth light source, such as, for example, an integrated distributed feedback laser (DFB), which may optionally be tunable, or which may optionally operate at a specific peak wavelength. The light source may optionally include an amplifier (not shown) to amplify the intensity of the light, although this is not required. In one or more embodiments of the invention, the light source and the electro-absorption modulator may be monolithically integrated on the same chip, although the scope of the invention is not limited in this respect.

The electro-absorption modulator is an example of an external light intensity reducer and modulator. In one or more embodiments of the invention, the light source may provide nearly constant intensity light to the electro-absorption modulator, and the electro-absorption modulator may modulate the intensity of the light based, at least in part, on the modulation signal received from the impedance matching circuit.

In one or more embodiments of the invention, the electro-absorption modulator may modulate the light by absorbing light and may include a semiconductor material having a property that absorption of light depends, at least in part, on voltage applied thereto. Suitable semiconductor materials having such a property include, but are not limited to, materials that include both one or more Group IIIA elements and one or more Group VA elements. By way of example, suitable semiconductor materials having such a property include, but are not limited to, materials that include at least one of indium, gallium and aluminum, and at least one of phosphorus and arsenic.

The semiconductor material may be optically coupled to receive the light from the light source and electrically coupled to receive the modulation signal from the impedance matching circuit. The semiconductor material may modulate the intensity of the light by absorbing different amounts of the light based, at least in part, on different voltages of the modulation signal. Without wishing to be bound by theory, the different voltages may change the electric field across the semiconductor material, which may change the semiconductor bandgap, which may in turn change the absorption of the light by the semiconductor material. Absorption of the light may reduce the intensity of the light that is transmitted or otherwise output from the semiconductor material. In an aspect, the absorption may be rapidly switched between relatively strongly absorbing to relatively non-absorbing.

The modulated light, which may optionally represent network data, may be transmitted or otherwise provided as an optical signal 134. In one or more embodiments of the invention, one or more optical fibers may be coupled with or connected to the optical transmitter and the optical signals may be communicated via the optical fibers to a network.

Now, a particular optical transmitter has been described. In addition to the impedance matching circuit, the optical transmitter includes the driver, the electro-absorption modulator, and the light source. To illustrate certain concepts, various potential details of the driver, the electro-absorption modulator, and the light source have been provided, however the driver, the electro-absorption modulator, and the light source do not limit the scope of the invention. Each of these components may optionally be conventional and may perform conventionally. Aside from the slight coupling modifications to accommodate the impedance matching circuit between the driver and the electro-absorption modulator, these components do not require substantial modification in order to practice embodiments of the invention. The scope of the invention should not be limited by these components or the specific details provided for these components. Other embodiments of the invention may be practiced with materially different components and with other optical transmitters entirely.

Now, embodiments of the invention relate to methods of making optical transmitters, such as, for example, the optical transmitter shown in FIG. 1, or portions thereof that include impedance matching circuits as disclosed herein.

An exemplary method, according to one or more embodiments of the invention, may include forming an equalizer circuit on a circuit board, printing or otherwise forming a first resistor (R₁) that is coupled between the equalizer circuit and ground on the circuit board, and coupling one or more other optical transmitter components with the circuit board by mounting the components on the circuit board.

As discussed above, in one or more embodiments of the invention, the equalizer circuit may include an inductor and a second resistor (R₂) that is electrically coupled in parallel with the inductor. A method of forming such an equalizer circuit, according to one or more embodiments of the invention, may include printing the second resistor (R₂) on the circuit board, and connecting a wirebond, such as, for example, a gold wirebond, across the second resistor (R₂) in order to form the inductor.

Various optical transmitter components may optionally be mounted or surface mounted on the circuit board. Specific examples include, but are not limited to, the driver and the electro-absorption modulator. The driver may be mounted such that it is coupled in series with the equalizer circuit. The electro-absorption modulator may be mounted such that it is coupled in series with the equalizer circuit and in parallel with the resistor.

Alternate methods are also contemplated. For example, in one or more embodiments of the invention, resistors and/or inductors may be surface mounted on the circuit board.

Simulations were performed using Advanced Design System, which is commercially available from Agilent Technologies, in order to determine the return loss performance of an optical transmitter having an impedance matching circuit similar to that shown in FIG. 1. The simulations assumed an L₁ of 0.8 nH, an R₁ of 50 Ohms, and an R₂ of 40 Ohms. The simulations also assumed the circuit representation shown in FIG. 2 and the values of the circuit components disclosed above.

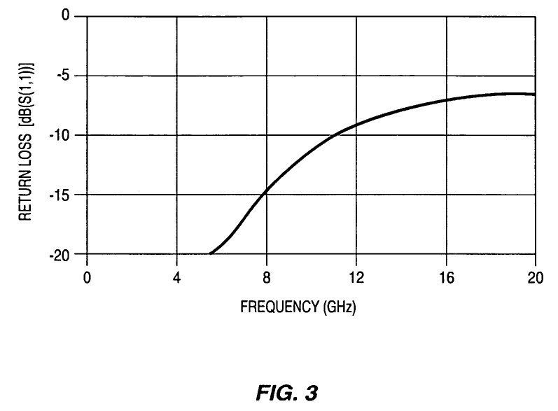

FIG. 3 shows simulated return loss for an optical transmitter having an impedance matching circuit and equalizer circuit as a function of modulation frequency, according to one or more embodiments of the invention. The return loss is expressed in decibels (dB) and is plotted on the y-axis, while the frequency is expressed in gigahertz (GHz) and is plotted on the x-axis.

The return loss is a metric that may represent and/or quantify imperfect electrical coupling between the driver and the electro-absorption modulator due, at least in part, to impedance mismatch. The return loss involves the log₁₀ of the ratio of the amplitude of a modulation signal reflected by an impedance mismatch between the driver and electro-absorption modulator to the amplitude of a modulation signal incident to the impedance mismatch. Generally the greater the impedance mismatch the greater the amplitude of the reflected signal and the greater the ratio. Since the ratio is generally less than one, and since the logarithm is taken, a smaller or more negative return loss may imply better impedance matching between the driver and the electro-absorption modulator.

The illustrated return loss increases as a function of frequency over the range of frequencies considered. As shown, at frequencies of about 4 to 5 GHz the return loss may be around −20 dB. Likewise, at frequencies of about 10 GHz the return loss may be about −11 dB, which is generally sufficient for a 10 GHz optical transmitter.

Additional simulations were performed in order to determine the effect of removing the equalizer circuit on the return loss. In the additional simulations, the equalizer circuit was omitted from the impedance matching circuit but the first resistor (R₁) was retained. Comparison indicates that the return losses for the impedance matching circuit with the equalizer circuit were consistently better than return losses for the impedance matching circuit without the equalizer circuit for frequencies ranging from at least 2 to 20 GHz. By way of example, at a frequency of 10 GHz, the optical transmitter having the equalizer circuit had a return loss that was about 8 dB lower than the optical transmitter omitting the equalizer circuit. This indicates that the impedance matching circuit may benefit the operation of a 10 GHz transmitter.

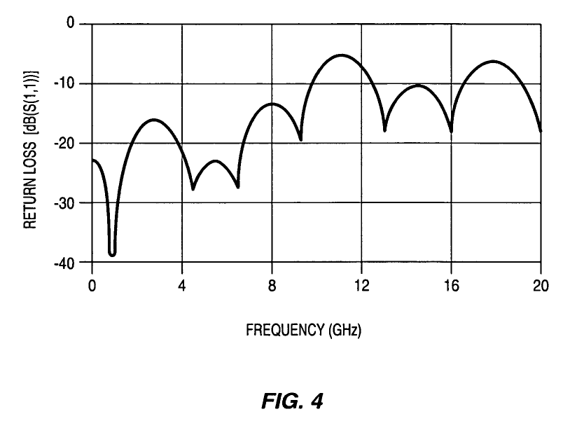

Measurements were taken for an optical transmitter having an impedance matching circuit and an equalizer circuit similar to those described in the simulations. FIG. 4 shows measured return loss for an optical transmitter having an impedance matching circuit and equalizer circuit as a function of modulation frequency, according to one or more embodiments of the invention. As shown, the return loss may increase as a function of frequency over the range of frequencies considered. The ripples in the illustrated plot of the return loss are believed to be an artifact due to an added transmission length due to the evaluation board, which affected the return loss. At frequencies of about 10 GHz the return loss may be about −10 to −15 dB. Such a return loss may be sufficient for a 10 GHz optical transmitter.

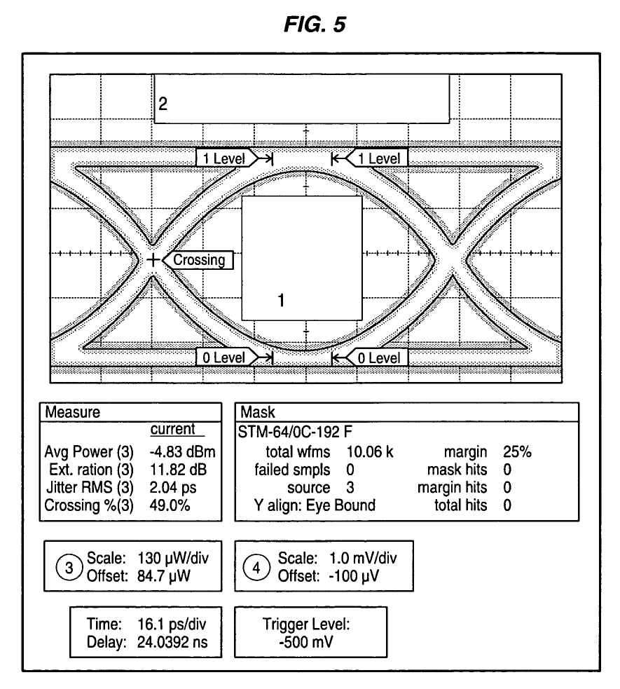

FIG. 5 shows measured filtered optical eye for an optical transmitter having an impedance matching circuit and equalizer circuit, according to one or more embodiments of the invention. The impedance matching circuit and equalizer circuit were the same as those used for the simulations described above. The optical eye was determined at 10.7 gigabits-per-second (Gb/s). The openness of the illustrated optical eye is generally favorable and there is little ringing on the “1” and “0” levels. This further demonstrates sufficient impedance matching between the driver and the electro-absorption modulator.

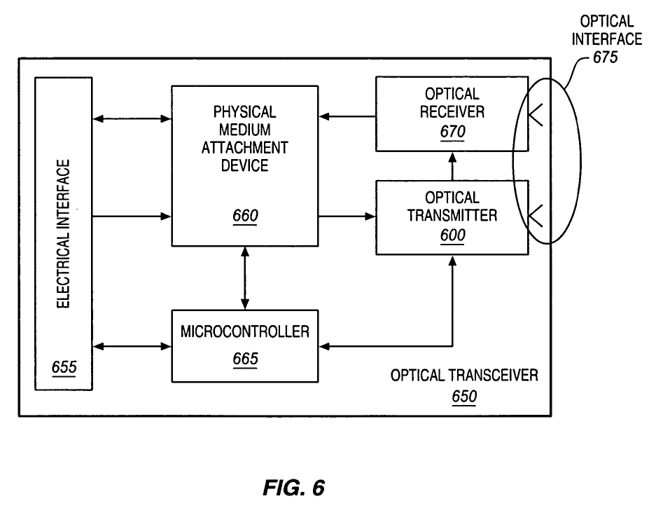

FIG. 6 is a block diagram of an optical transceiver 650, according to one or more embodiments of the invention. The optical transceiver includes an electrical interface 655, a physical medium attachment device 660, a microcontroller 665, an optical receiver 670, an optical transmitter 600 in accordance with one or more embodiments of the invention, and an optical interface 675.

For clarity, as used herein, an optical transceiver includes both an optical transmitter and an optical receiver. Since the optical transceiver includes an optical transmitter and is capable of transmitting and is regarded herein as an optical transmitter

The electrical interface may be physically and/or electrically coupled with a host electronic device, such as, for example, a switch, router, server, or other network device. The electrical interface may exchange electrical signals with the host electronic device. Representative signals that may be exchanged include, but are not limited to, input/output data transfer, various clocking channels, control and monitoring channels, and DC power and ground connections. However, the scope of the invention is not limited with regard to these electrical signals. Suitable physical forms of the electrical interface include, but are not limited to, a socket that may plug into a host board and a board-edge connection that may mate with a socket in a host board. In various embodiments of the invention, the interface may include an XAUI interface (10 Gigabit. Attachment Unit Interface) or a XFI interface (10 Gigabit Serial Electrical Interface), such as, for example, in order to provide data rates of about 10 Gb/s, according to different multi-source agreements.

The physical medium attachment (PMA) device is electrically coupled with the electrical interface and may exchange electrical signals with the electrical interface. The PMA device may include circuits or other logic to provide much or most of the core electrical functionality of the transceiver. The PMA device may take the form of clock multiplier/multiplexer (MUX/CMU) and clock and data recovery/demultiplexer (CDR/DeMUX). By way of example, in order to transmit data, the MUX/CMU may interleave a multi-channel data signal into a serialized data stream at the line rate clocked by a multiplied version of the input clock, which may ultimately be modulated by the optical transmitter. The CDR/DeMUX may provide the complementary functionality on the receive side. Functionalities included in some optical transceivers include, but are not limited to, phase adjustment, co-alignment, line de-skewing, decoding, rate adjustment, scrambling, encoding, serialization, deskew, and de-serialization.

The microcontroller is electrically coupled with the electrical interface and may exchange electrical signals with the electrical interface. The microcontroller may provide a control system for the optical transceiver. By way of example, the microcontroller may perform functions, such as, for example, setting control parameters for the physical medium attachment device, transmitter, and receiver. The microcontroller may also optionally allow the host electronic device to set control parameters and read status registers. As an alternative to the microcontroller, analog hardware may also optionally be used.

The optical receiver is electrically coupled with the PMA device and may provide electrical signals representing received data to the PMA device. The optical transmitter is electrically coupled with the PMA device and may receive electrical signals representing received data from the PMA device. The optical transmitter and receiver are also electrically coupled with the microcontroller to receive control signals.

In one or more embodiments of the invention, the optical transmitter may be packaged to form an optical transmitter package known as a Transmitter Optical Sub-Assembly (TOSA). Likewise, in one or more embodiments of the invention, the optical receiver may be separately packaged to form an optical receiver package known as a Receiver Optical Sub-Assembly (ROSA). The optical transmitter and receiver packages may optionally have hermetic seals.

Various embodiments of the invention pertain to optical transmitters having impedance matching circuits as disclosed herein, portions of optical transmitters having impedance matching circuits disclosed herein, TOSAs having impedance matching circuits as disclosed herein, optical transceivers having impedance matching circuits as disclosed herein, and optical transceivers having TOSAs having impedance matching circuits as disclosed herein. Still other embodiments pertain to host electronic devices coupled or otherwise interacting with one of such devices having an impedance matching circuit.

The optical transmitter and receiver may provide the optical interface that may allow the optical transceiver to be connected with an optical path, such as, for example, to a fiber optic transmission medium including one or more optical fibers. In operation, the optical transmitter may receive electrical signals from the host electronic device via the electrical interface and PMA device, convert the electrical signals into optical signals, and transmit the optical signals to a network via the optical interface. The optical receiver may receive optical signals from the network via the optical interface, convert the optical signals into electrical signals, and provide the electrical signals to the host electronic device via the PMA device and electrical interface.

Now, in order to illustrate certain concepts a particular optical transceiver, in which one or more embodiments of the invention may be implemented, has been described. However, the scope of the invention is not limited to this particular optical transceiver. The electrical interface, PMA device, microcontroller, optical receiver, and optical interface do not limit the scope of the invention. These components may be conventional and do not require substantial modification in order to practice embodiments of the invention. The scope of the invention should not be limited by these components or the specific details provided for these components. Additionally, other embodiments of the invention may be practiced with materially different components and with other optical transceivers entirely.

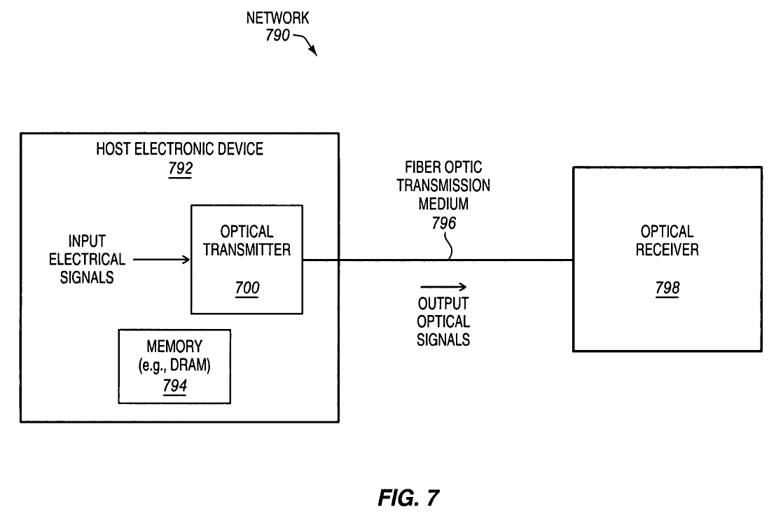

FIG. 7 is a block diagram of a network 790, according to one or more embodiments of the invention. The network includes a host electronic device 792, an optical transmitter 700, a fiber optic transmission medium 796, and an optical receiver 798.

Suitable host electronic devices include, but are not limited to, switches, routers, servers, and other network devices. Personal computers, such as, for example, desktops and laptops, are also suitable.

As shown, the host electronic device may include a memory 794. In one or more embodiments of the invention, the memory may include volatile memory such as dynamic random-access memory (DRAM). The DRAM may optionally be provided via single in-line memory modules (SIMMs). However, the use of DRAM is not required. DRAM is used in some, but not all, host electronic devices and network devices. Other memories that may also optionally be used in network devices and other host electronic devices include, but are not limited to, static random-access memory (SRAM) and Flash memory.

The optical transmitter may be physically and/or electronically coupled with the host electronic device. For example, in one or more embodiments of the invention, the optical transmitter may be plugged directly into the host electronic device. As another example, in one or more embodiments of the invention, the optical transmitter may be included in a card, such as, for example, a line or peripheral components interconnect (PCI) card, or a host bus adapter, or like device, which may be plugged directly into the host electronic device.

The optical transmitter may receive electrical signals from the host electronic device. The optical transmitter may convert the electrical signals into corresponding optical signals, and transmit the optical signals to the optical receiver over the fiber optic transmission medium.

Now, the scope of the invention is not limited to just box-to-box interconnection. In one or more embodiments of the invention, the optical transmitters and impedance matching circuits disclosed herein may be coupled with boards to provide board-to-board interconnection. For example, the optical transmitters and impedance matching circuits disclosed herein may be included on a blade, or other board-level form factor device, which may be plugged into a chassis in order to provide interconnection with another board-level form factor device. As another option, in one or more embodiments of the invention, the optical transmitters and impedance matching circuits disclosed herein may be coupled with boards to provide optical backplanes. As yet another option, in one or more embodiments of the invention, the optical transmitters and impedance matching circuits disclosed herein may be coupled with chips or a chip to provide high-speed short-distance chip-to-chip or on-chip optical interconnection.

In the description above, for the purposes of explanation, numerous specific details have been set forth in order to provide a thorough description of embodiments of the invention. It will be apparent however, to one skilled in the art, that one or more other embodiments may be practiced without some of these specific details. The description is to be regarded as illustrative instead of limiting. In other instances, well-known circuits, structures, devices, and operations have been shown in block diagram form or without detail in order to avoid obscuring the understanding of the description.

It will also be appreciated, by one skilled in the art, that modifications may be made to the embodiments disclosed herein, such as, for example, to the sizes, configurations, functions, materials, and manner of operation of the components of the embodiments. All equivalent relationships to those illustrated in the drawings and described in the specification are encompassed within embodiments of the invention.

Certain operations and methods have been described in a basic form, but operations may optionally be added to and/or removed from the methods. The operations of the methods may also often optionally be performed in different order.

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Accordingly, while the invention has been thoroughly described in terms of several embodiments, those skilled in the art will recognize that the invention is not limited to the particular embodiments described, but may be practiced with modification and alteration within the spirit and scope of the appended claims.

What is claimed is:

1. An apparatus comprising:
an equalizer circuit;
a resistor coupled between the equalizer circuit and ground; and
a light intensity modulator coupled in series with the equalizer circuit and coupled in parallel with the resistor.

2. The apparatus of claim 1, wherein the equalizer circuit comprises:
an inductor; and
a second resistor that is coupled in parallel with the inductor.

3. The apparatus of claim 2, wherein:
the resistor has between 25 to 100 Ohms;
the inductor has between 0.4 to 1.5 nH; and
the second resistor has between 15 to 50 Ohms.

4. The apparatus of claim 2, wherein:
the second resistor comprises a printed circuit board resistor; and
the inductor comprises a wirebond connected across the printed circuit board resistor.

5. The apparatus of claim 1, wherein impedance of the equalizer circuit increases with increasing frequency of a signal provided thereto.

6. The apparatus of claim 1, wherein at least a portion of the equalizer circuit and the resistor are printed on a printed circuit board, and wherein the electro-absorption modulator is mounted on the printed circuit board.

7. The apparatus of claim 1, further comprising a light source to provide light to the electro-absorption modulator.

8. The apparatus of claim 7, further comprising a driver coupled with the equalizer circuit to provide a modulation signal thereto.

9. The apparatus of claim 1, further comprising a receiver optical sub-assembly.

10. A system comprising:
a network device comprising a DRAM memory; and
an optical transmitter coupled with the network device, the optical transmitter including an impedance matching circuit including:
an equalizer circuit coupled in series with a driver of an electro-absorption modulator to receive a signal therefrom and coupled in series with the electro-absorption modulator to provide a signal thereto; and
a resistor coupled between the equalizer circuit and ground and coupled in parallel with the electro-absorption modulator.

11. The system of claim 10, wherein the equalizer circuit comprises:
an inductor; and
a second resistor that is coupled in parallel with the inductor.

12. The system of claim 11, wherein:
the resistor has between 25 to 100 Ohms;
the inductor has between 0.4 to 1.5 nH; and
the second resistor has between 15 to 50 Ohms.

13. The system of claim 11, wherein:
the second resistor comprises a printed circuit board resistor; and
the inductor comprises a wirebond connected across the printed circuit board resistor.

14. The system of claim 10, wherein impedance of the equalizer circuit increases with increasing frequency of the signal received from the driver.

15. A method comprising:
forming an equalizer circuit on a circuit board;
printing a resistor that is coupled between the equalizer circuit and ground on the circuit board; and
coupling a driver of an electro-absorption modulator in series with the equalizer circuit by mounting the driver on the printed circuit board.

16. The method of claim 15, wherein forming the equalizer circuit comprises:
printing a second resistor on the circuit board; and
connecting a wirebond across the second resistor.

17. The method of claim 16, further comprising coupling an electro-absorption modulator in series with the equalizer circuit and in parallel with the resistor by mounting the electro-absorption modulator on the printed circuit board.

18. A method comprising:
providing a signal to an equalizer circuit of an impedance matching circuit;
receiving a portion of the signal from the equalizer circuit at a resistor of the impedance matching circuit that is coupled between the equalizer circuit and ground;
receiving a portion of the signal at an electro-absorption modulator that is coupled in series with the equalizer circuit and coupled in parallel with the resistor; and
modulating light with the electro-absorption modulator based at least in part on the received portion of the signal.

19. The method of claim 18, wherein said providing the signal to the equalizer circuit comprises providing a first portion of the signal to an inductor and providing a second portion of the signal to a second resistor that is coupled in parallel with the inductor.

20. The method of claim 18, wherein said providing the signal to the equalizer circuit comprises providing a modulation signal from a driver that is coupled in series with the equalizer circuit.
